(19) United States
(12) Patent Application Publication
(10) Pub. No.: US 2026/0146735 A1
(43) Pub. Date: May 28, 2026

(54) HEATING APPARATUS FOR A FLUID CONVEYING LINE

(71) Applicant: 2698669 Alberta Ltd., Lloydminster (CA)

(72) Inventors: Leslie Dale Unrau, Lloydmintser (CA); Kent Burgan McLeod, Lloydminster (CA)

(21) Appl. No.: 19/094,083

(22) Filed: Mar. 28, 2025

Related U.S. Application Data
(60) Provisional application No. 63/724,467, filed on Nov. 25, 2024.

(51) Int. Cl. F23D 99/00; F02M 21/02; F02M 21/06

(52) U.S. Cl. CPC F23D 99/005; F02M 21/0215; F02M 21/06

(57) ABSTRACT

A fluid line heater has a burner and a heat exchanger in heat exchanging relation with an exhaust chamber of the burner. A fluid conduit directs fluid from the fluid line through the heat exchanger tank. One or more heat exchanger conduits extend at an upward slope across the exhaust chamber in open communication at spaced locations with the surrounding heat exchanger tank to form an endless loop of heat exchanger fluid with the tank. Naturally rising heated fluid in the conduits generate a cyclical current to improve heat transfer efficiency. An air intake is elevated relative to the burner, alongside the tank to preheat burner combustion air. An access duct communicates through part of the heat exchanger tank adjacent the heat exchanger conduits for cleaning tool access to remove soot or other debris from heat exchanging surfaces to further improve heat transfer efficiency.

This application claims the benefit under 35 U.S.C. 119 (e) of U.S. provisional application Ser. No. 63/724,467, filed Nov. 25, 2024.

### FIELD OF THE INVENTION

The present invention relates to an apparatus for heating a fluid conveyed in a line, for example natural gas transported in a pipeline or other liquid or gas conveyed in line, and more particularly the present invention relates to a fluid line heating apparatus having a burner for consuming fuel to generate heat and a heat exchanger with a liquid heat exchanger fluid therein for heating a fluid line receiving the fluid by exchanging heat between the burner and the fluid line.

### BACKGROUND

Natural gas is commonly transported over long distances using high pressure pipelines. Branch lines extending from the high-pressure pipeline further transport the natural gas to various regions of use remote from the pipeline, in which the branch lines are typically operated at a lower pressure. The drop in pressure of the gas from the main pipeline to a branch line, together with low temperatures in many regions introduces a risk of the gas freezing in the lines. Line heaters are commonly used to provide some added heat to the fuel in the lines to prevent such freezing the gas in the lines. Due to the remote location of a typical line heater, where electrical power may not be available in abundance, it is desirable for the line heater to operate as efficiently as possible with minimal electrical power requirements.

### SUMMARY OF THE INVENTION

According to one aspect of the invention there is provided a fluid line heating apparatus for heating a fluid conveyed in a fluid line, the apparatus comprising:
a burner for combusting a fuel to generate heated exhaust;
an exhaust chamber in communication with the burner so as to be arranged to receive the heated exhaust;
a heat exchanger tank in heat exchanging relationship with the exhaust chamber and arranged to contain a heat exchanger liquid therein;
a fluid conduit arranged for connection in line with the fluid line to receive the fluid from the fluid line passed through the fluid conduit, the fluid conduit being received within the heat exchanger tank in heat exchanging relationship with the heat exchanger liquid therein; and
at least one heat exchanger conduit extending across the exhaust chamber between a first end and a second end of the heat exchanger conduit;
wherein the first end and the second end of said at least one heat exchanger conduit are in open communication with the heat exchanger tank at spaced apart locations such that the heat exchanger conduit forms an endless loop with the heat exchanger tank for receiving the heat exchanger liquid from the heat exchanger tank therein; and
wherein the second end of said at least one heat exchanger conduit is higher in elevation than the first end of said at least one heat exchanger conduit;
whereby the heat exchanger fluid within said at least one heat exchanger conduit rises towards the second end of said at least one heat exchanger conduit as the heat exchanger fluid is heated by the heated exhaust in the exhaust chamber so as to drive cyclical flow of the heat exchanger fluid about the endless loop.

In this manner, the heat exchanger liquid in the conduits which becomes heated and therefore less dense, will naturally rise along the upward flow path along the length of each conduit from the first end to the second end thereof to generate a current. The current in the conduits will in turn drive a returning current of heat exchanger liquid in the main portion of the heat exchanger tank where the fluid conduit is located to optimize transfer of heat from the heat exchanger liquid in the tank to the fluid in the fluid conduit. The resulting circulation of fluid improves the heat transfer efficiency of the line heater in a passive manner that does not require any additional power input other than the normal combustion of fuel by the burner.

The fluid line is preferably a natural gas fuel line containing natural gas therein.

Preferably said at least one heat exchanger conduit only increases in elevation along a full length of the heat exchanger conduit between the first end and the second end thereof. In this instance, said at least one heat exchanger conduit may be linearly sloped between the first end and the second end thereof.

The apparatus may include a plurality of the heat exchanger conduits spaced apart from one another, in which the first ends of the heat exchanger conduits are in communication with a common first end of the heat exchanger tank and the second ends of the heat exchanger conduits are in communication with a common second end of the heat exchanger tank.

One or more lowermost conduits among the heat exchanger conduits preferably have a continuous and uninterrupted exterior surface along a length of the heat exchanger conduit, while one or more uppermost conduits among the heat exchanger conduits may include a plurality of heat exchanger fins protruding from an exterior surface of the heat exchanger conduit at spaced apart locations, in which the one or more uppermost conduits being located above the one or more lowermost conduits.

When the heat exchanger tank extends longitudinally between a first end and a second end of the heat exchanger tank, the second end of said at least one heat exchanger conduit is preferably in proximity to the second end of the heat exchanger tank, and the fluid conduit is preferably nearer to the second end of the heat exchanger tank than the first end of the heat exchanger tank.

The apparatus may include an exhaust stack in communication with the exhaust chamber so as to extend upwardly from the exhaust chamber through a portion of the heat exchanger tank. When the heat exchanger tank extends longitudinally between a first end and a second end of the heat exchanger tank, the first end of said at least one heat exchanger conduit is preferably in proximity to the first end of the heat exchanger tank, and the exhaust stack is preferably nearer to the first end of the heat exchanger tank than the second end of the heat exchanger tank.

The apparatus may further include one or more conduit baffles supported within the heat exchanger tank to define at least one baffle conduit separated from a remaining main portion of the heat exchanger tank receiving the fluid conduit therein, in which the at least one baffle conduit extends alongside the exhaust chamber between a first end of the baffle conduit in communication with the main portion of the heat exchanger tank in proximity to the first end of said at least one heat exchanger conduit and a second end of the baffle conduit in communication with the main portion of the heat exchanger tank in proximity to the second end of said at least one heat exchanger conduit.

Preferably the one or more conduit baffles of the at least one baffle conduit include an upper boundary baffle in which the upper boundary baffle is sloped upwardly from the first end to the second end of the baffle conduit.

The apparatus may further include at least one flow baffle supported on a side boundary of the heat exchanger tank in proximity to the fluid conduit so as to direct the cyclical flow within the heat exchanger into close proximity with the fluid conduit.

When the apparatus includes an exhaust stack in communication with the exhaust chamber so as to extend upwardly from the exhaust chamber through a portion of the heat exchanger tank, preferably the apparatus also includes at least one flow baffle supported on a side boundary of the heat exchanger tank in proximity to the exhaust stack so as to direct the cyclical flow within the heat exchanger into close proximity with the fluid conduit.

The apparatus may further include a combustion air intake duct extending downwardly alongside a first end of the heat exchanger tank from an intake opening receiving air therein to an outlet opening in communication with the burner for delivering the air to the burner for combustion of the fuel.

In the illustrated embodiment, the first end of said at least one heat exchanger conduit is in proximity to the first end of the heat exchanger tank.

The apparatus may further include an access duct communicating through a portion of the heat exchanger tank between a first end of the access duct located externally of the heat exchanger tank and a second end of the access duct in open communication with the exhaust chamber adjacent to said at least one heat exchanger conduit. When providing a combustion air intake duct extending downwardly alongside a first end of the heat exchanger tank from an intake opening receiving air therein to an outlet opening in communication with the burner for delivering the air to the burner for combustion of the fuel, preferably the second end of the access duct terminates within the intake duct and the second end of the access duct includes a removable cover arranged to selectively close the access duct.

According to a second aspect of the present invention there is provided a fluid line heating apparatus for heating a fluid conveyed in a fluid line, the apparatus comprising:
a burner for combusting a fuel to generate heated exhaust;
an exhaust chamber in communication with the burner so as to be arranged to receive the heated exhaust;
a heat exchanger tank in heat exchanging relationship with the exhaust chamber and arranged to contain a heat exchanger liquid therein;
a fluid conduit arranged for connection in line with the fluid line to receive the fluid from the fluid line passed through the fluid conduit, the fluid conduit being received within the heat exchanger tank in heat exchanging relationship with the heat exchanger liquid therein; and
a combustion air intake duct extending downwardly alongside a first end of the heat exchanger tank from an intake opening receiving air therein to an outlet opening in communication with the burner for delivering the air to the burner for combustion of the fuel.

In this arrangement, the intake opening is desirably located spaced upwardly from the burners at a high elevation to protect the intake opening, while also providing some preheating of the combustion air flowing alongside the heat exchanger tank.

According to a third aspect of the present invention there is provided a fluid line heating apparatus for heating a fluid conveyed in a fluid line, the apparatus comprising:
a burner for combusting a fuel to generate heated exhaust;
an exhaust chamber in communication with the burner so as to be arranged to receive the heated exhaust;
a heat exchanger tank in heat exchanging relationship with the exhaust chamber and arranged to contain a heat exchanger liquid therein;
a fluid conduit arranged for connection in line with the fluid line to receive the fluid from the fluid line passed through the fluid conduit, the fluid conduit being received within the heat exchanger tank in heat exchanging relationship with the heat exchanger liquid therein;
at least one heat exchanger conduit extending across the exhaust chamber between a first end and a second end of the heat exchanger conduit; and
an access duct communicating through a portion of the heat exchanger tank between a first end of the access duct in open communication with the exhaust chamber adjacent to said at least one heat exchanger conduit and a second end of the access duct located externally of the heat exchanger tank.

When providing a combustion air intake duct extending downwardly alongside a first end of the heat exchanger tank from an intake opening receiving air therein to an outlet opening in communication with the burner for delivering the air to the burner for combustion of the fuel, preferably the second end of the access duct terminates within the intake duct and the second end of the access duct includes a removable cover arranged to selectively close the access duct.

The access duct provides access for a cleaning tool, for example a compressed air dispensing nozzle, to extend into the region of the exhaust chamber where the heat exchanger conduits are located so that the cleaning tool can remove any soot or other debris from the heat exchanging surfaces of the conduits to maximize heat transfer into the fluid within the conduits.

### BRIEF DESCRIPTION OF THE DRAWINGS

One embodiment of the invention will now be described in conjunction with the accompanying drawings in which:

FIG. 1 is a perspective view of the fluid line heating apparatus;

FIG. 2 is a sectional view along the line 2-2 in FIG. 1;

FIG. 3 is a perspective view of the fluid line heating apparatus in which some components have been removed for illustrative purposes;

FIG. 4 is a sectional view along the line 4-4 in FIG. 1;

FIG. 5 is a sectional view along the line 5-5 in FIG. 1; and

FIG. 6 is a sectional view along the line 6-6 in FIG. 1.

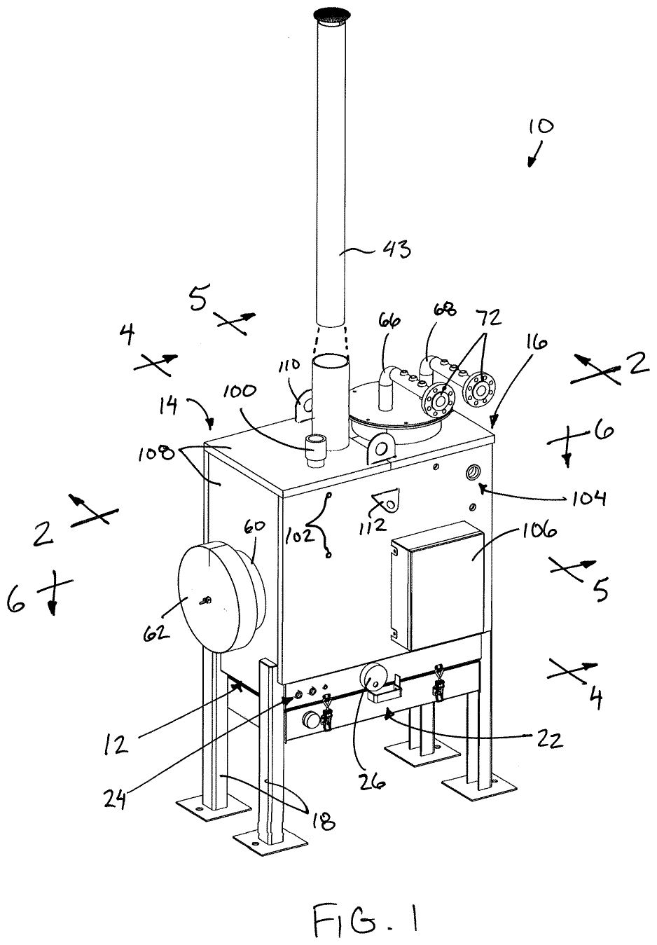

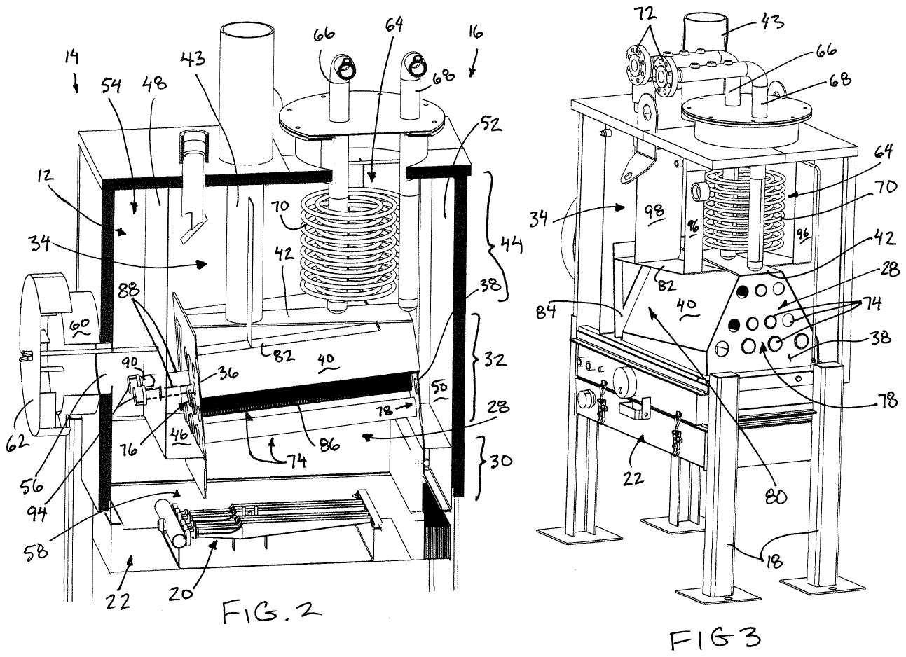

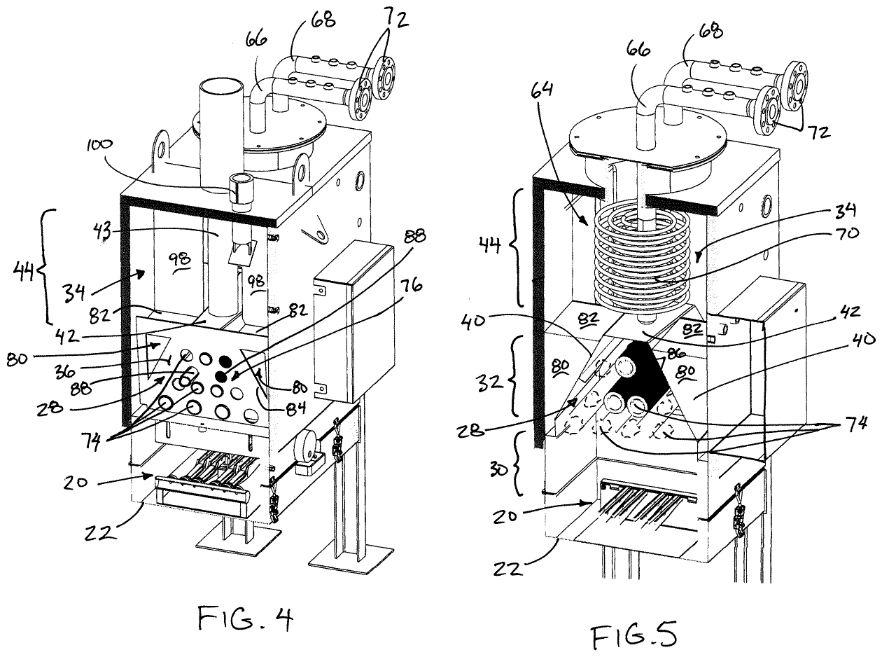

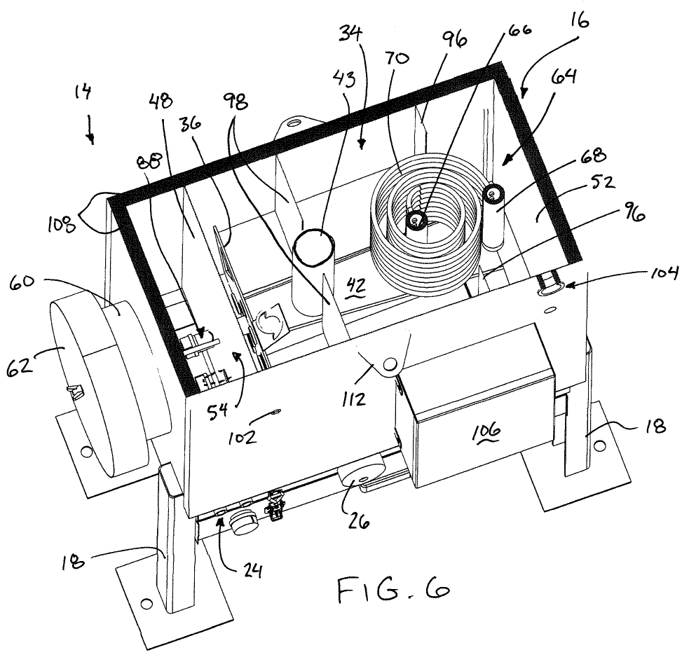

In the drawings like characters of reference indicate corresponding parts in the different figures.

### DETAILED DESCRIPTION

Referring to the accompanying figures there is illustrated a fluid line heating apparatus generally indicated by reference numeral 10. The apparatus 10 is particularly suited for heating natural gas fuel flowing in a fluid line such as a natural gas pipeline, by passing the natural gas through the apparatus in heat exchanging relationship with a source of heat, for example derived from the combustion of a hydrocarbon fuel.

The apparatus 10 includes a main housing 12 which is elongate in a longitudinal direction between a first end 14 and an opposing second end 16. A plurality of legs 18 support the housing 12 spaced above ground or a suitable foundation.

A burner assembly 20 is supported within the housing adjacent a bottom end of the housing and includes one or more burners supplied with fuel, for example natural gas, for combusting the fuel to produce heat. A bottom portion 22 of the housing at least partially surrounds the burner assembly. The bottom portion 22 encloses an area below the burner assembly and is coupled to the main portion of the housing 20 by a suitable arrangement of hinges and latches so that the bottom of the housing can be selectively opened for access to the burners for maintenance and the like.

A plurality of burner ports 24 communicate through the housing in association with the burner assembly to receive gas lines for the burners and a pilot light, as well as electrical ignition components communicating through the housing in proximity to the bottom end where the burner assembly is located. A sight glass 26 may also be incorporated into the boundary of the housing adjacent the bottom end to provide a visual line of sight through the sight glass to the pilot light area of the burner assembly to confirm ignition of the pilot light.

An exhaust chamber 28 is located within the housing to extend upwardly above the burner assembly while being open at the bottom for receiving the heated exhaust gases resulting from the combustion of fuel by the burners 20. A lower portion 30 of the exhaust chamber includes upright boundary walls which are substantially vertically oriented to define a perimeter boundary within which the burner assembly is laterally contained so that exhaust gases are directed upwardly into the exhaust chamber.

The exhaust chamber further includes an upper portion 32 which extends upwardly into a heat exchanger tank 34 to be described in further detail below. The upper portion 32 spans a majority of a length of the heat exchanger tank in the longitudinal direction between a first end wall 36 and a second end wall 38 at opposing ends of the exhaust chamber which are upright and near vertical in orientation. More particularly, the first end wall 36 is spaced longitudinally inward towards the second end wall relative to a corresponding first end of the heat exchanger tank and the second end wall 38 is spaced longitudinally inward towards the first end wall relative to a corresponding second end of the heat exchanger tank.

The upper portion 32 of the exhaust chamber further includes side walls 40 spanning a full length between the first end wall 36 and the second end wall 38 at laterally opposing sides of the exhaust chamber such that the side walls are tapered upwardly and laterally inwardly towards one another across the height thereof. A top wall 42 is connected generally horizontally between the opposing side walls 40 while spanning substantially the full length between the end walls together with the side walls. An overall height of the upper portion 32 of the exhaust chamber defined primarily by the side walls 40 is near but slightly less than half of the overall height of the surrounding heat exchanger tank 34.

The exhaust chamber communicates with an exhaust stack 44 in the form of a vertical pipe in open communication through the top wall 42 of the exhaust chamber such that the vertical pipe extends upwardly through part of the heat exchanger tank 34, and then continues to extend upwardly through a top wall of the housing 12 to terminate externally of the housing at a location spaced above the housing. The products of combustion from the burner, in the form of heated exhaust, are communicated upwardly through the exhaust chamber 28 to be subsequently exhausted externally through the stack 44. The exhaust stack 44 is laterally centred relative to the opposing side boundaries of the housing 12 and the heat exchanger tank 34 defined therein while being offset in a longitudinal direction to be nearer to a first end of the tank corresponding to a first end of the exhaust chamber and the first end of the housing than a second end of the tank corresponding to the second end of the exhaust chamber and the second end of the housing.

The heat exchanger tank 34 is an enclosed tank suitable for containing liquid heat exchanging fluid therein, for example glycol. The heat exchanger tank 34 is elongate in a longitudinal direction between a first end in proximity to the first end 14 of the housing and a second end in proximity to the second end 16 of the housing. The heat exchanger tank 34 fully occupies a width of the housing while being slightly wider than the exhaust chamber 28 so that a portion of the exhaust tank extends longitudinally along each of the laterally opposing sides of the exhaust chamber 28 between the longitudinally opposed ends thereof.

The heat exchanger tank 34 has a height which is two times more or greater than a height of the exhaust chamber 28 received in the bottom end of the heat exchanger tank such that the heat exchanger tank includes a main portion 44 above the exhaust chamber which spans a full length of the tank between the opposing first and second ends thereof. The length of the heat exchanger tank is slightly greater than a length of the exhaust chamber in the longitudinal direction such that the heat exchanger tank includes a first end portion 46 between the first end wall 36 of the heat exchanger tank and a corresponding first end wall 48 of the tank 34 which is in open communication with the main portion 44 of the tank thereabove. The heat exchanger tank 34 similarly includes a second end portion 50 between the second end wall 38 of the heat exchanger tank and a corresponding second end wall 52 of the heat exchanger tank which is an open communication with the main portion 44 of the tank thereabove. The second end wall 52 of the heat exchanger tank coincides with an end wall at the second end 16 of the housing.

The first end wall 48 of the heat exchanger tank is spaced longitudinally inward from the corresponding end wall of the housing at the first end 14 towards the opposing second end 16 of the housing to define a gap therebetween. The gap is occupied by an intake duct 54 extending a full height of the housing between the first end wall 48 of the heat exchanger tank and the corresponding end wall at the first end 14 of the housing 12. The intake duct 54 is vertically oriented along the first end of the heat exchanger tank for communication vertically downwardly from an intake opening 56 of the intake duct at an intermediate location along the height and an outlet opening 58 at the bottom of the intake duct which is open to the chamber surrounding the burner assembly at the bottom of the housing. The intake duct 54 thus serves to supply combustion air therethrough for the burner while pre-heating the air due to a heat exchanging relationship across the boundary of the heat exchanger tank at the first end wall 48 thereof.

The intake opening 56 communicates through the end wall of the housing at the first end 14 thereof at a location spaced upwardly from the bottom of the housing. An inlet pipe 60 is mounted on the housing in communication with the intake opening 56 to protrude longitudinally outward from the first end 14 of the housing. A flame arrestor cover 62 is releasably mounted over top of the open outer end of the inlet pipe 60 using removable threaded fasteners. Removing the fasteners permits the baffle arrangement of the flame arrestor 62 to be removed for access to the interior of the housing through the inlet pipe for maintenance and the like as described in further detail below.

The apparatus 10 further includes a fluid conduit 64 in communication through a top wall of the housing for being received within the main portion 44 of the heat exchanger tank 34. The fluid conduit 64 includes a first pipe 66 and a second pipe 68 mounted vertically and parallel to one another to communicate through the top of the housing. Within the interior of the heat exchanger tank, a plurality of branch lines 70 communicate between the first pipe 66 and the second pipe 68 in the form of a coil of branch lines. Pipe flanges 72 are situated at the exterior ends of the first pipe 66 and the second pipe 68 to permit the fluid conduit 64 to be connected in line with a gas line containing gas therein. In this manner the gas is transported into one of the first pipe 66 and the second pipe 68 for subsequent circulation through the branch lines 70 in a heat exchanging relationship with the surrounding heat exchanger fluid in the tank 34, followed by exhausting of the heated gas through the other one of the first pipe 66 and the second pipe 68 to be returned to the gas line. The branch lines 70 serve to increase the heat exchange surface area of the fluid conduit receiving gas from the gas line circulated therethrough in heat exchanging relationship with the liquid in the tank 34.

The apparatus 10 further includes a plurality of heat exchange conduits 74 mounted within the exhaust chamber 28 in fluid communication with the heat exchange liquid in the heat exchanger tank 34. Each heat exchange conduit is a tubular pipe having a first end 76 openly communicating with the tank through the first end wall 36 of the exhaust chamber and a second end 78 openly communicating with the tank through the second end wall 38 of the exhaust chamber. The heat exchanger conduit 74 are sealed relative to the exhaust chamber to prevent direct mixing of the heat exchanger liquid within the conduit 74 and the exhaust within the exhaust chamber while permitting heat exchanging relationship across the boundary walls of the heat exchanger conduits which are surrounded with heated exhaust rising upwardly through the exhaust chamber.

Each heat exchange conduit 74 is a linear pipe which is sloped upwardly from the first end 76 to the second end 78 thereof so that the second end is higher in elevation than the first end and such that the elevation of the pipe steadily increases across the full length of the pipe between the first end 76 and the second end 78 thereof. All of the first ends of the conduits 74 commonly communicate with the first end portion 46 of the heat exchanger tank, while all of the second ends 78 of the conduit 74 commonly communicate with the second end portion 50 of the heat exchanger tank. The conduits 74 thus communicate with the main portion 44 of the tank at spaced apart locations at opposing ends of the tank such that each of the conduits forms an endless loop together with the main portion 44 of the tank above.

In operation, heat from the exhaust rising up through the exhaust chamber 28 surrounds the heat exchanger conduit 74 to heat the heat exchange liquid within the conduits 74. Heating of the fluid causes the density of the fluid to decrease so that the heated fluid naturally rises by convection towards the second ends 78 of the conduits 74 to generate a current within the conduits from the first end towards the second end of the conduits. This results in fluid from the main portion 44 of the tank being drawn into the first end portion 46 to replenish fluid within the conduits 74 at the first ends thereof. Meanwhile the excess fluid accumulating at the second end portion 50 of the tank flows upwardly into the main portion 44 at the second end thereof. This in turn generates an opposing current from the second end towards the first end of the tank across the main portion 44 occupying the upper half of the heat exchanger tank. Continued heating of fluid within the heat exchanger conduits 74 results in a continued cyclical flow induced by the currents described above so that the heat exchanger liquid within the tank continuously circulates in the endless loop defined by the open communication of the conduit 74 with the main portion 44 at opposing ends thereof.

In addition to the heat exchanger conduits 74 extending through the exhaust chamber 28 described above, a pair of auxiliary conduits 80 are defined along laterally opposing sides of the tapered upper portion of the exhaust chamber. Each auxiliary conduit 80 is defined by a respective conduit baffle 82 in the form of a boundary wall which is connected between a side boundary wall of the heat exchanger tank 34 and a corresponding side wall 40 of the exhaust chamber in proximity to the top end thereof. Each baffle 82 spans a length in the longitudinal direction that is near to the length of the exhaust chamber 28 without protruding into the first end portion 46 or the second end portion 50 of the heat exchanger tank 34 at opposing ends thereof. Each auxiliary conduit 80 (or baffled conduit) is a triangular-shaped conduit defined by the conduit baffle 82, a corresponding side wall of the heat exchanger tank 34, and a corresponding side wall 40 of the exhaust chamber, while being in heat exchanging relationship with the exhaust chamber through the side wall thereof. The conduit baffle 82 forms the upper boundary wall of the conduit 80 in which the baffle is sloped upwardly in the longitudinal direction from the first end to the second end thereof corresponding to the first end 14 and second end 16 of the housing.

Opposing ends of the auxiliary conduit 80 are in open communication with the first end portion 46 and the second end portion 50 of the heat exchanger tank such that the auxiliary conduits 80 also form an endless loop with the main portion 44 of the heat exchanger tank similarly to the heat exchanger conduits 74 described above. In operation, liquid within the auxiliary conduits 80 is heated by heat exchanging relationship through the side walls 40 of the exhaust chamber so that the density of the liquid decreases. The rising fluid encounters the sloped upper boundary wall defined by the conduit baffle 82 to generate a flow from the first end to the second end which further contributes to the cyclical flow in an endless loop within the heat exchanger tank.

An end baffle 84 having an aperture formed therein is located at the first end of each auxiliary conduit 80 in which the aperture in the end baffle is slightly reduced in cross-sectional area compared to the remainder of the auxiliary conduit 80. The aperture size is selected so as to partly restrict flow within each auxiliary conduit 82 ensure a balanced flow of liquid through the tubular heat exchanger conduits 74 and the auxiliary conduits 80. By ensuring that flow of the heat exchanger liquid is relatively even between all of the different conduits, heat is exchanged from the exhaust chamber to the heat exchanger liquid more evenly in a distributed manner.

The tubular heat exchanger conduits 74 that extend across the exhaust chamber are provided in laterally oriented rows so as to be parallel and spaced apart from one another. The rows include a top row of three laterally spaced conduits 74, a middle row of four laterally spaced conduits 74, and a bottom row of four laterally spaced conduits 74. The conduits 74 in the top and middle rows define uppermost conduits in which the outer surface of each conduit includes a plurality of heat exchanger fins 86 mounted thereon to protrude from the conduit in a spaced apart relationship. The fins 86 are formed of conductive material to increase the heat exchanging surface of the uppermost conduits.

The conduits 74 in the bottom row define lowermost conduits in which the outer surfaces of the lowermost conduits are generally smooth, continuous and uninterrupted. As the lowermost conduits are closest to the source of heat from the burners below, sufficient heat transfer occurs without the necessity of additional fins. After some heat has already been removed from the exhaust, the fins 86 on the uppermost conduits increase the heat transfer to the liquid in the uppermost conduits so that heat transferred to the uppermost conduits is somewhat balanced with the heat transfer to the fluid in the lowermost conduits despite the uppermost conduits being further from the heat source.

In order to enable cleaning of the fins 86 of the uppermost conduits, a pair of access ducts 88 are provided for communicating through the first end portion 46 of the heat exchanger tank for communication of cleaning tools therethrough. The tubular heat exchange conduits 74 of the top row are spaced from the conduits of the middle row by a greater vertical distance than the space between the middle row and the bottom row of conduits 74. This increased vertical gap between the top row and middle row is aligned with the access ducts 88 to again provide greater access for cleaning tools. Each access ducts 88 includes a first end 90 which terminates within the intake duct 54 in horizontal and lateral alignment with the intake opening 56. The access ducts 88 also include respective second ends 92 which are in open communication with the exhaust chamber in alignment with the increased vertical gap between the top row and middle row of conduits 74.

A cover 94 is releasably attached to the first end 90 of each access duct using threaded fasteners so that the cover can be readily mounted and removed as desired. When the cover is closed, no communication of air is permitted through the access ducts 88 so that under normal operation of the heating apparatus, air entering the apparatus through the intake duct can only be communicated to the exhaust chamber by being discharged downwardly through the intake duct to the burner assembly for assisting combustion of fuel by the burner followed by rising upwardly from the burner assembly through the exhaust chamber.

Alternatively, when cleaning is desired, operation of the heating apparatus is ceased so that the flame arrestor cover 62 can be removed from the intake opening 56 followed by removal of the covers 94 from the access ducts 88 so that a compressed air discharging nozzle can be inserted through the access ducts to dislodge soot and other debris collected on the heat exchanger fins 86 by discharged compressed air.

To further enhance heat transfer efficiency, the fluid conduit 64 is located within the main portion of the tank to be closer to the second end thereof where the heat exchanger liquid is hottest following heat exchanging relationship with the exhaust chamber through the conduits 74 and 80. In addition, a pair of flow baffles 96 are mounted on the laterally opposing side boundary walls of the heat exchanger tank. The baffles 96 are generally perpendicular to the longitudinal direction so as to be upright in orientation while extending laterally partway inwardly towards the opposing side wall. The resulting gap between the baffles 96 closely fits the coil of the fluid conduit 64 received therein. In this manner the cyclical flow within the main portion of the tank is directed or forced to flow closely through and around the coil of the fluid conduit to increase the heat exchange efficiency with the fuel to be heated within the fluid conduit 64.

The exhaust stack 44 extends through the main portion of the heat exchanger tank to be closer to the first end of the tank than the second end of the tank. A corresponding pair of flow baffles 98 are mounted on the laterally opposing side boundary walls of the heat exchanger tank so as to be likewise perpendicular to the longitudinal direction. The baffles 98 are aligned with the stack 44 to extend laterally partway inwardly towards one another such that the stack 44 occupies most of the gap between the baffles 98. In this manner, the cyclical flow within the main portion of the tank is also directed or forced to flow in close proximity, adjacent and around the stack 44 to increase the heat exchange efficiency with the exhaust rising upwardly through the stack 44. Specifically, after the heat exchange fluid has been cooled by transfer of heat to the fuel in the fluid conduit, the cooled heat exchange fluid flows around the stack so that residual heat in the exhaust stack can be transferred to the cooled heat exchanger liquid flowing around the stack.

After collecting heat from the stack, the heat exchanger fluid flows along the first end wall of the heat exchanger tank 34 to preheat combustion air in the intake duct 54 across the first end wall of the heat exchanger tank. The heat exchanger fluid is then drawn into the first ends of the conduit 74 and 80 to be again heated by exchanging heat with the exhaust gases in the exhaust chamber to continue to urge the cyclical flow longitudinally from the first end to the second end within the conduits and from the second end to the first end through the main portion of the tank.

The apparatus 10 further includes a fill port 100 communicating through the top wall of the housing in alignment with the heat exchanger tank through which the exchanger liquid can be introduced into the tank to replenish lost fluid if required.

A pair of gauge ports 102 communicate through one of the side boundaries of the tank at vertically spaced locations in open communication with fluid in the tank so that an external transparent gauge tube connected between the gauge ports provides a visual indication of the level of fluid within the heat exchanger tank.

Additional operating ports 104 also communicate through the side boundary of the housing and the heat exchanger tank to provide wiring access for a pressure indicator, a temperature sensor, and a level switch that assist in monitoring operations of the apparatus 10.

A control box 106 is mounted externally on a side boundary wall of the tank. The common boundary wall of the control box 106 and the tank is uninsulated to allow some heat transfer into the control box which locates various control elements therein. Specifically, the control box can include a temperature controller and a gas valve control.

A layer of insulation 108 is provided about the exterior boundary walls of the housing including laterally opposed side walls, two end walls, and the top wall.

Various anchors are provided on the housing which are connected to the rigid boundary walls of the housing and communicate through the insulation layer for shipping and handling of the apparatus 10. The anchors include two lift anchors 110 mounted on the top wall of the housing to protrude through the insulation layer at laterally opposing sides of the housing at a longitudinally centred location. The lift anchors 110 provide balanced lifting points for connection to lift cables for moving the apparatus.

The anchors also include two tie down anchors 112 which are secured to laterally opposing side walls of the apparatus 10 to protrude laterally outwardly through the insulation layer at opposing sides of the housing. The tie down anchors 112 provide an anchoring location for securing tie down straps during transport without damage to the exterior insulation layer on the housing.

Since various modifications can be made in the invention as herein above described, and many apparently widely different embodiments of same made, it is intended that all matter contained in the accompanying specification shall be interpreted as illustrative only and not in a limiting sense.

1. A fluid line heating apparatus for heating a fluid conveyed in a fluid line, the apparatus comprising:
a burner for combusting a fuel to generate heated exhaust;
an exhaust chamber in communication with the burner so as to be arranged to receive the heated exhaust;
a heat exchanger tank in heat exchanging relationship with the exhaust chamber and arranged to contain a heat exchanger liquid therein;
a fluid conduit arranged for connection in line with the fluid line to receive the fluid from the fluid line passed through the fluid conduit, the fluid conduit being received within the heat exchanger tank in heat exchanging relationship with the heat exchanger liquid therein; and
at least one heat exchanger conduit extending across the exhaust chamber between a first end and a second end of the heat exchanger conduit;
wherein the first end and the second end of said at least one heat exchanger conduit are in open communication with the heat exchanger tank at spaced apart locations such that the heat exchanger conduit forms an endless loop with the heat exchanger tank for receiving the heat exchanger liquid from the heat exchanger tank therein; and
wherein the second end of said at least one heat exchanger conduit is higher in elevation than the first end of said at least one heat exchanger conduit;
whereby the heat exchanger fluid within said at least one heat exchanger conduit rises towards the second end of said at least one heat exchanger conduit as the heat exchanger fluid is heated by the heated exhaust in the exhaust chamber so as to drive cyclical flow of the heat exchanger fluid about the endless loop.

2. The apparatus according to claim 1 wherein the fluid line is a natural gas fuel line containing natural gas therein.

3. The apparatus according to claim 1 wherein said at least one heat exchanger conduit only increases in elevation along a full length of the heat exchanger conduit between the first end and the second end thereof.

4. The apparatus according to claim 1 wherein said at least one heat exchanger conduit is linearly sloped between the first end and the second end thereof.

5. The apparatus according to claim 1 wherein said at least one heat exchanger conduit comprises a plurality of heat exchanger conduits which are spaced apart from one another, the first ends of the heat exchanger conduits being in communication with a common first end of the heat exchanger tank and the second ends of the heat exchanger conduits being in communication with a common second end of the heat exchanger tank.

6. The apparatus according to claim 5 wherein one or more lowermost conduits among the heat exchanger conduits have a continuous and uninterrupted exterior surface along a length of the heat exchanger conduit, and wherein one or more uppermost conduits among the heat exchanger conduits include a plurality of heat exchanger fins protruding from an exterior surface of the heat exchanger conduit at spaced apart locations, the one or more uppermost conduits being located above the one or more lowermost conduits.

7. The apparatus according to claim 1 wherein the heat exchanger tank extends longitudinally between a first end and a second end of the heat exchanger tank, wherein the second end of said at least one heat exchanger conduit is in proximity to the second end of the heat exchanger tank, and wherein the fluid conduit is nearer to the second end of the heat exchanger tank than the first end of the heat exchanger tank.

8. The apparatus according to claim 1 further comprising an exhaust stack in communication with the exhaust chamber so as to extend upwardly from the exhaust chamber through a portion of the heat exchanger tank, wherein the heat exchanger tank extends longitudinally between a first end and a second end of the heat exchanger tank, wherein the first end of said at least one heat exchanger conduit is in proximity to the first end of the heat exchanger tank, and wherein the exhaust stack is nearer to the first end of the heat exchanger tank than the second end of the heat exchanger tank.

9. The apparatus according to claim 1 further comprising one or more conduit baffles supported within the heat exchanger tank to define at least one baffle conduit separated from a remaining main portion of the heat exchanger tank receiving the fluid conduit therein, the at least one baffle conduit extending alongside the exhaust chamber between a first end of the baffle conduit in communication with the main portion of the heat exchanger tank in proximity to the first end of said at least one heat exchanger conduit and a second end of the baffle conduit in communication with the main portion of the heat exchanger tank in proximity to the second end of said at least one heat exchanger conduit.

10. The apparatus according to claim 9 wherein the one or more conduit baffles of the at least one baffle conduit include an upper boundary baffle in which the upper boundary baffle is sloped upwardly from the first end to the second end of the baffle conduit.

11. The apparatus according to claim 1 further comprising at least one flow baffle supported on a side boundary of the heat exchanger tank in proximity to the fluid conduit so as to direct the cyclical flow within the heat exchanger into close proximity with the fluid conduit.

12. The apparatus according to claim 1 further comprising (i) an exhaust stack in communication with the exhaust chamber so as to extend upwardly from the exhaust chamber through a portion of the heat exchanger tank and (ii) at least one flow baffle supported on a side boundary of the heat exchanger tank in proximity to the exhaust stack so as to direct the cyclical flow within the heat exchanger into close proximity with the fluid conduit.

13. The apparatus according to claim 1 further comprising a combustion air intake duct extending downwardly alongside a first end of the heat exchanger tank from an intake opening receiving air therein to an outlet opening in communication with the burner for delivering the air to the burner for combustion of the fuel.

14. The apparatus according to claim 1 wherein the first end of said at least one heat exchanger conduit is in proximity to the first end of the heat exchanger tank.

15. The apparatus according to claim 1 further comprising an access duct communicating through a portion of the heat exchanger tank between a first end of the access duct located externally of the heat exchanger tank and a second end of the access duct in open communication with the exhaust chamber adjacent to said at least one heat exchanger conduit.

16. The apparatus according to claim 15 further comprising a combustion air intake duct extending downwardly alongside a first end of the heat exchanger tank from an intake opening receiving air therein to an outlet opening in communication with the burner for delivering the air to the burner for combustion of the fuel, wherein the second end of the access duct terminates within the intake duct, and wherein the second end of the access duct includes a removable cover arranged to selectively close the access duct.

17. A fluid line heating apparatus for heating a fluid conveyed in a fluid line, the apparatus comprising:
a burner for combusting a fuel to generate heated exhaust;
an exhaust chamber in communication with the burner so as to be arranged to receive the heated exhaust;
a heat exchanger tank in heat exchanging relationship with the exhaust chamber and arranged to contain a heat exchanger liquid therein;
a fluid conduit arranged for connection in line with the fluid line to receive the fluid from the fluid line passed through the fluid conduit, the fluid conduit being received within the heat exchanger tank in heat exchanging relationship with the heat exchanger liquid therein; and
a combustion air intake duct extending downwardly alongside a first end of the heat exchanger tank from an intake opening receiving air therein to an outlet opening in communication with the burner for delivering the air to the burner for combustion of the fuel.

18. A fluid line heating apparatus for heating a fluid conveyed in a fluid line, the apparatus comprising:
a burner for combusting a fuel to generate heated exhaust;
an exhaust chamber in communication with the burner so as to be arranged to receive the heated exhaust;
a heat exchanger tank in heat exchanging relationship with the exhaust chamber and arranged to contain a heat exchanger liquid therein;
a fluid conduit arranged for connection in line with the fluid line to receive the fluid from the fluid line passed through the fluid conduit, the fluid conduit being received within the heat exchanger tank in heat exchanging relationship with the heat exchanger liquid therein;
at least one heat exchanger conduit extending across the exhaust chamber between a first end and a second end of the heat exchanger conduit; and
an access duct communicating through a portion of the heat exchanger tank between a first end of the access duct in open communication with the exhaust chamber adjacent to said at least one heat exchanger conduit and a second end of the access duct located externally of the heat exchanger tank.

19. The apparatus according to claim 18 further comprising a combustion air intake duct extending downwardly alongside a first end of the heat exchanger tank from an intake opening receiving air therein to an outlet opening in communication with the burner for delivering the air to the burner for combustion of the fuel, wherein the second end of the access duct terminates within the intake duct, and wherein the second end of the access duct includes a removable cover arranged to selectively close the access duct.
